(19) United States
(12) Patent Application Publication
(10) Pub. No.: US 2026/0038729 A1
(43) Pub. Date: Feb. 5, 2026

(54) MULTILAYER INDUCTOR

(71) Applicant: Murata Manufacturing Co., Ltd., Kyoto-fu (JP)

(72) Inventor: Yutaka NOGUCHI, Nagaokakyo-shi (JP)

(73) Assignee: Murata Manufacturing Co., Ltd., Kyoto-fu (JP)

(21) Appl. No.: 19/354,167

(22) Filed: Oct. 9, 2025

Related U.S. Application Data
(63) Continuation of application No. PCT/JP2024/021711, filed on Jun. 14, 2024.

(30) Foreign Application Priority Data
Sep. 8, 2023 (JP) 2023-146310

(51) Int. Cl. H01F 27/28; H01F 1/147; H01F 27/29; H01F 27/32

(52) U.S. Cl. CPC H01F 27/2804; H01F 1/14766; H01F 27/292; H01F 27/323; H01F 2027/2809

(57) ABSTRACT

A multilayer inductor that further suppresses reduction in the magnetic permeability while ensuring the insulation property is provided. A multilayer inductor according to the present disclosure includes a body including a magnetic body in which metal magnetic layers containing metal magnetic particles are laminated together, a coil, in the magnetic body, that is formed by winding coil conductors, and an insulating body disposed between the coil conductors in a lamination direction. The insulating body includes a contact portion, in contact with the coil conductors, that extends in a direction orthogonal to the lamination direction, and protruding portions, provided at both ends of the contact portion in the direction orthogonal to the lamination direction, that extend outward of both sides of each of the coil conductors in the direction orthogonal to the lamination direction, and the thickness of the protruding portions is smaller than the thickness of the contact portion.

### CROSS-REFERENCE TO RELATED APPLICATION

This application claims benefit of priority to International Patent Application No. PCT/JP2024/021711, filed Jun. 14, 2024, and to Japanese Patent Application No. 2023-146310, filed Sep. 8, 2023, the entire contents of each are incorporated herein by reference.

### BACKGROUND

### Technical Field

The present disclosure relates to a multilayer inductor.

### Background Art

Japanese Unexamined Patent Application Publication No. 2018-6411 (see claim 1 and FIG. 3) discloses a multilayer coil component in which the average particle diameter of soft magnetic metal powder located inside a coil as viewed in the Z direction is made greater than the average particle diameter of soft magnetic metal powder located between coil conductors adjacent to each other in the Z direction to enhance the magnetic permeability of a body.

In addition, Japanese Unexamined Patent Application Publication No. 2017-228768 (see claim 3 and FIG. 3) discloses a coil component in which the width dimension orthogonal to a uniaxial direction of a plurality of insulating body portions is equal to or greater than the width dimension orthogonal to a uniaxial direction of a plurality of winding portions to ensure stable electrical insulation between the winding portions.

### SUMMARY

The multilayer coil component described in Japanese Unexamined Patent Application Publication No. 2018-6411 achieves insulation by using a low-magnetic permeability portion including soft magnetic metal powder located between the coil conductors. However, since the width dimension in the X direction of the low-magnetic permeability portion (see FIG. 3 of Japanese Unexamined Patent Application Publication No. 2018-6411) is approximately the same as the width dimension in the X direction of the coil conductor, there is concerns regarding insulation reliability.

In contrast, in the coil component described in Japanese Unexamined Patent Application Publication No. 2017-228768 (see FIG. 3), a width dimension Ws of an insulating body portion is greater than a width dimension Wc of a winding portion. However, the flow of the magnetic flux is reduced by the insulating body portion that protrudes from the winding portion, and accordingly, the magnetic permeability of the entire coil component is reduced.

Accordingly, the present disclosure provides a multilayer inductor that further suppresses reduction in the magnetic permeability while ensuring the insulation property.

According to the present disclosure, there is provided a multilayer inductor including a body including a magnetic body in which metal magnetic layers containing metal magnetic particles are laminated together, a coil, disposed in the magnetic body, that is formed by winding coil conductors, and an insulating body disposed between the coil conductors in a lamination direction. The insulating body includes a contact portion, in contact with the coil conductors, that extends in a direction orthogonal to the lamination direction, and protruding portions, provided at both ends of the contact portion in the direction orthogonal to the lamination direction, that extend outward of both sides of each of the coil conductors in the direction orthogonal to the lamination direction. Also, a thickness of the protruding portions is smaller than a thickness of the contact portion.

According to the present disclosure, it is possible to provide a multilayer inductor that further suppresses reduction in the magnetic permeability while ensuring the insulation property. Specifically, since the insulating body disposed between the coil conductors in the lamination direction includes the contact portion, in contact with the coil conductors, that extends in a direction intersecting the lamination direction and the protruding portions that extend outward of both sides of each of the coil conductors in the direction intersecting the lamination direction, the insulation property can be ensured. In addition, in the insulating body disposed between the coil conductors in the lamination direction, since the thickness of the protruding portions that protrude outward of both sides of each of the coil conductors is smaller than the thickness of the contact portion in contact with the coil conductors, reduction in the flow of magnetic flux due to the insulating body is suppressed, and reduction in the magnetic permeability can be further suppressed.

### BRIEF DESCRIPTION OF THE DRAWINGS

FIG. 1 is a perspective view of a multilayer inductor according to the present disclosure;

FIG. 2 is an exploded perspective view of a multilayer inductor according to a first embodiment;

FIG. 3 is a cross-sectional view as viewed from arrows III-III in FIG. 2;

FIG. 4 is an enlarged cross-sectional view of a main portion in FIG. 3;

FIG. 5 is a cross-sectional view of a multilayer inductor according to another embodiment;

FIG. 6 is a cross-sectional view of a multilayer inductor according to a second embodiment;

FIG. 7 is an enlarged cross-sectional view of a main portion in FIG. 6; and

FIGS. 8A to 8G are explanatory diagrams for describing a manufacturing method of the multilayer inductor according to the present disclosure.

### DETAILED DESCRIPTION

A multilayer inductor according to the present disclosure will be described below. It should be noted that the present disclosure is not limited to the following structure and may be changed as appropriate without departing from the spirit of the present disclosure. In addition, combinations of individual preferred structures described below are also included in the present disclosure.

The multilayer inductor according to the present disclosure is used in, for example, a DC-to-DC converter. In addition, the inductor according to the present disclosure is also applicable to uses other than a DC-to-DC converter.

In this specification, terms that indicate the relationships between elements (for example, parallel, orthogonal, and the like) and terms that indicate the shapes of elements mean not only the strictly literal aspects but also substantially equivalent ranges including differences of approximately a few percent. It should be noted that, in this specification, the direction in which magnetic layers and coil conductors that constitute the body are laminated together is referred to as a lamination direction.

In addition, in the description of this specification, references to directions or orientations are made merely for the convenience of description and are not intended to limit the scope of the present disclosure unless otherwise explicitly stated. For example, relative terms, such as outer (or outer side, outer portion, or outer periphery), inner (or inner side, inner portion, or inner periphery), and their derived terms should be understood as references to the directions as described or illustrated. That is, unless otherwise explicitly stated, the disclose is not limited only to a particular direction, orientation, or form. In addition, terms, such as “provided”, “disposed”, and “connected” and their derived terms are also similar, and are not limited to direct aspects and may be aspects in which other elements, such as intervening objects, may be present therebetween unless otherwise explicitly stated.

The diagrams illustrated below are schematic diagrams, and the dimensions, the scales of aspect ratios, and the like may differ from those of the actual product.

### <Inductor According to First Embodiment>

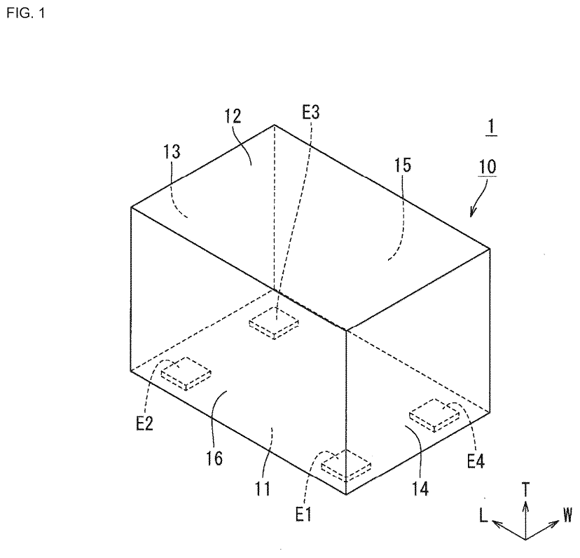

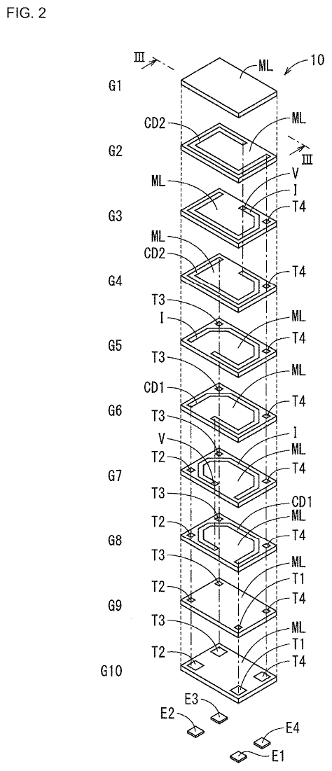

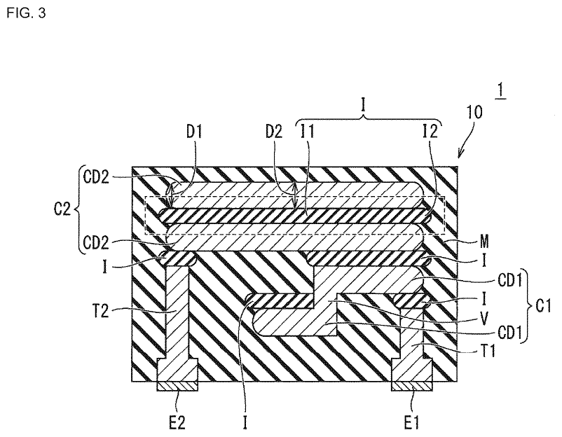

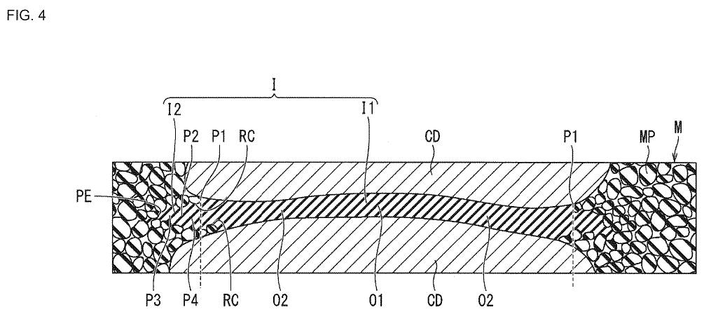

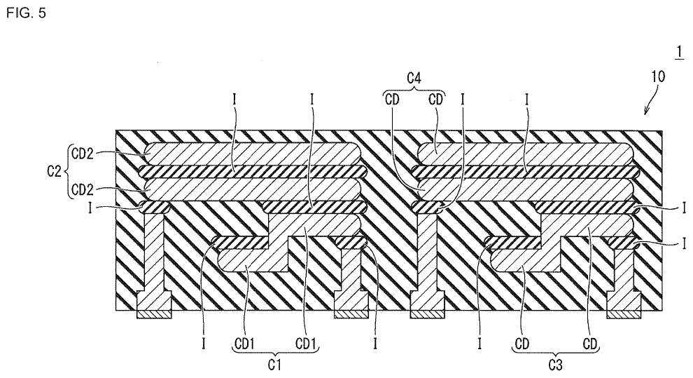

A multilayer inductor according to a first embodiment will be described with reference to FIGS. 1 to 5. FIG. 1 is a perspective view of the multilayer inductor according to the present disclosure, FIG. 2 is an exploded perspective view of the multilayer inductor according to the first embodiment, FIG. 3 is a cross-sectional view as viewed from arrows III-III in FIG. 2, FIG. 4 is an enlarged cross-sectional view of a main portion in FIG. 3, and FIG. 5 is a cross-sectional view of a multilayer inductor according to another embodiment. It should be noted that the shapes, the dispositions, and the like of the multilayer inductor and individual components are not limited to the illustrated examples.

A multilayer inductor 1 according to the first embodiment includes a body 10 that includes a magnetic body M in which metal magnetic layers ML (see FIG. 2) containing metal magnetic particles MP (see FIG. 4) are laminated together, a coil C, disposed in the magnetic body M, that is formed by winding coil conductors CD, and an insulating body I disposed between the coil conductors CD in the lamination direction.

In the embodiment, the body 10 includes a first coil C1 and a second coil C2 disposed above the first coil C1 in a height direction T. The first coil C1 is wound in the body 10 by multilayer groups G6 to G8 (see FIG. 2), which will be described later, being laminated together, and first coil conductors CD1 between layers being spirally connected to each other through a via conductor V (see FIG. 3). The second coil C2 is wound in the body 10 by multilayer groups G2 to G4 (see FIG. 2), which will be described later, being laminated together, and the second coil conductors CD2 between layers being spirally connected to each other through a via conductor (not illustrated).

It should be noted that the coils included in the body 10 are not limited to the example described above and may be an example including one coil or an example including two or more coils. For example, an example in which the body 10 includes four coils C1 to C4 as illustrated in FIG. 5 may be adopted. Specifically, the third coil C3 provided in the body 10 illustrated in FIG. 5 may be disposed in a direction orthogonal to the lamination direction with respect to the first coil C1, and the fourth coil C4 may be disposed in a direction orthogonal to the lamination direction with respect to the second coil C2.

Individual components will be described in detail below.

### —Body—

The body 10 has, for example, a rectangular parallelepiped shape having six surfaces or a substantially rectangular parallelepiped shape. The body 10 may have rounded corner portions and rounded ridge portions. The corner portion is a portion at which the three surfaces of the body 10 intersect each other, and the ridge line portion is a portion at which two surfaces of the body 10 intersect each other.

In FIG. 1, the length direction, the width direction, and the height direction of the multilayer inductor 1 and the body 10 are indicated as an L direction, a W direction, and a T direction, respectively. The length direction L, the width direction W, and the height direction T are orthogonal to each other. The mount surface of the multilayer inductor 1 is, for example, a surface (LW surface) parallel to the length direction L and the width direction W.

The body 10 illustrated in FIG. 1 has a first main surface 11 and a second main surface 12 that face away from each other in the height direction T, a first end face 13 and a second end face 14 that are orthogonal to each other in the height direction T and face away from each other in the length direction L, and a first side surface 15 and a second side surface 16 that face away from each other in the width direction W orthogonal to both the length direction L and the height direction T. In the example illustrated in FIG. 1, the first main surface 11 of the body 10 corresponds to the mount surface (bottom surface) of the body 10. It should be noted that the second main surface 12 may be the mount surface of the body 10.

The body 10 includes the magnetic body M, the coil C, and the insulating body I. In addition, the body 10 has a multilayer structure in which a metal magnetic layer ML, a plurality of metal magnetic layers ML each including the insulating body I and the coil conductor CD, and a plurality of metal magnetic layers ML each including the insulating body I are laminated together in the lamination direction (for example, in the height direction T). In the embodiment, as illustrated in FIG. 2, the body 10 is formed by laminating a multilayer group G1 to a multilayer group G10 each including at least one metal magnetic layer ML and a coil conductor CD (or only a metal magnetic layer ML). It should be noted that the boundaries of the layers of the multilayer structure of the body 10 have disappeared. In addition, the layers of the multilayer groups may be formed by laminating a plurality of layers with the same pattern together.

### (Multilayer Group G1)

The multilayer group G1 includes the metal magnetic layer ML and constitutes the second main surface 12 of the body 10.

### (Multilayer Group G2)

The multilayer group G2 includes the metal magnetic layer ML, the insulating body (not illustrated) provided on the metal magnetic layer ML, and the second coil conductor CD2 that constitutes a portion of the second coil C2 formed on the insulating body.

The second coil conductor CD2 of the multilayer group G2 constitutes one winding of the second coil C2. More specifically, the second coil conductor CD2 is disposed on an insulating body formed in the thickness direction of the metal magnetic layer ML along substantially the outer peripheral edge of the metal magnetic layer ML. One end of the second coil conductor CD2 is connected to a via conductor (not illustrated) for connecting to the second coil conductor CD2 provided on the insulating body of the metal magnetic layer ML of the multilayer group G4, and the other end of the second coil conductor CD2 is connected to a fourth through-hole conductor (not illustrated) for electrically connecting to a fourth outer electrode E4.

### (Multilayer Group G3)

The multilayer group G3 includes the metal magnetic layer ML, the insulating body I provided on the metal magnetic layer ML, the via conductor V provided on the insulating body I, and a fourth through-hole conductor T4 provided on the metal magnetic layer ML.

The insulating body I of the multilayer group G3 is provided so as to correspond to the winding shape of the second coil conductor CD2 of the multilayer group G4, which will be described later. In perspective plan view, the plane area of the insulating body I of the multilayer group G3 is designed to be greater than the plane area of the second coil conductor CD2 of the multilayer group G4. Accordingly, the insulating body I of the multilayer group G3 includes a region that overlaps the second coil conductor CD2 and a region that protrudes from the second coil conductor CD2 in perspective plan view. It should be noted that a region (a protruding portion I2 (see FIG. 3 or 4)) of the insulating body I that protrudes from the second coil conductor CD2 will be described in detail later.

The via conductor V of the multilayer group G3 is disposed at a position at which a connection is made to one end of the second coil conductor CD2 of the multilayer group G2.

The fourth through-hole conductor T4 of the multilayer group G3 connects, to each other, the fourth through-hole conductors T4 of the multilayer groups G2 and G4 that are adjacent to the multilayer group G3 in the lamination direction and is electrically connected to the fourth outer electrode E4. Accordingly, the fourth through-hole conductor T4 is disposed above the fourth outer electrode E4 in perspective plan view.

### (Multilayer Group G4)

The multilayer group G4 includes the metal magnetic layer ML, an insulating body (not illustrated) provided on the metal magnetic layer ML, the second coil conductor CD2, formed on the insulating body, that constitutes a portion of the second coil C2, and the fourth through-hole conductor T4 provided on the metal magnetic layer ML.

The second coil conductor CD2 of the multilayer group G4 constitutes another winding of the second coil C2. More specifically, the second coil conductor CD2 is disposed on the insulating body formed in the thickness direction of the metal magnetic layer ML along substantially the outer peripheral edge of the metal magnetic layer ML. One end of the second coil conductor CD2 is connected to the second coil conductor CD2 provided on the insulating body of the metal magnetic layer ML of the multilayer group G2, and the other end of the second coil conductor CD2 is connected to a third through-hole conductor (not illustrated) for electrically connecting to a third outer electrode E3.

The fourth through-hole conductor T4 of the multilayer group G4 connects, to each other, the fourth through-hole conductors T4 of the multilayer groups G3 and G5 adjacent to each other in the lamination direction and is electrically connected to the fourth outer electrode E4. Accordingly, the fourth through-hole conductor T4 may be disposed at a corner portion of the metal magnetic layer ML located above the fourth outer electrode E4.

### (Multilayer Group G5)

The multilayer group G5 includes the metal magnetic layer ML, the insulating body I provided on the metal magnetic layer ML, and a third through-hole conductor T3 and the fourth through-hole conductor T4 provided on the metal magnetic layer ML.

The insulating body I of the multilayer group G5 is provided so as to correspond to the winding shape of the first coil conductor CD1 of the multilayer group G6, which will be described later. In perspective plan view, the plane area of the insulating body I of the multilayer group G5 is designed to be greater than the plane area of the first coil conductor CD1 of the multilayer group G6. Accordingly, the insulating body I of the multilayer group G5 includes a region that overlaps the first coil conductor CD1 and a region that protrudes from the first coil conductor CD1 in perspective plan view. In addition, the insulating body I of the multilayer group G5 electrically insulates the first coil C1 from the second coil C2.

The third through-hole conductor T3 of the multilayer group G5 connects, to each other, the third through-hole conductors T3 of the multilayer groups G4 and G6 adjacent to each other in the lamination direction and is electrically connected to the third outer electrode E3. Accordingly, the third through-hole conductor T3 is disposed above the third outer electrode E3 in perspective plan view.

The fourth through-hole conductor T4 of the multilayer group G5 connects, to each other, the fourth through-hole conductors T4 of the multilayer groups G4 and G6 adjacent to each other in the lamination direction and is electrically connected to the fourth outer electrode E4. Accordingly, the fourth through-hole conductor T4 is disposed above the fourth outer electrode E4 in perspective plan view.

### (Multilayer Group G6)

The multilayer group G6 includes the metal magnetic layer ML, an insulating body (not illustrated) provided on the metal magnetic layer ML, the first coil conductor CD1, formed on the insulating body, that constitutes a portion of the first coil C1, and the third through-hole conductor T3 and the fourth through-hole conductor T4 that are provided on the metal magnetic layer ML.

The first coil conductor CD1 of the multilayer group G6 constitutes one winding of the first coil C1. More specifically, the first coil conductor CD1 is disposed on an insulating body formed in the thickness direction of the metal magnetic layer ML along substantially the outer peripheral edge of the metal magnetic layer ML. One end of the first coil conductor CD1 is provided with a via conductor (not illustrated) for connecting to the first coil conductor CD1 provided on the insulating body of the metal magnetic layer ML of the multilayer group G7, and the other end of the first coil conductor CD1 is provided with a second through-hole conductor (not illustrated) for electrically connecting to the second outer electrode E2.

The third through-hole conductor T3 of the multilayer group G6 connects, to each other, the third through-hole conductors T3 of the multilayer groups G5 and G7 adjacent to each other in the lamination direction and is electrically connected to the third outer electrode E3. Accordingly, the third through-hole conductor T3 may be disposed at a corner portion of the metal magnetic layer ML located above the third outer electrode E3.

The fourth through-hole conductor T4 of the multilayer group G6 connects, to each other, the fourth through-hole conductors T4 of the multilayer groups G5 and G7 adjacent to each other in the lamination direction and is electrically connected to the fourth outer electrode E4. Accordingly, the fourth through-hole conductor T4 may be disposed at a corner portion of the metal magnetic layer ML located above the fourth outer electrode E4.

### (Multilayer Group G7)

The multilayer group G7 includes the metal magnetic layer ML, the insulating body I provided on the metal magnetic layer ML, the via conductor V provided on the insulating body I, the second through-hole conductor T2, the third through-hole conductor T3, and the fourth through-hole conductor T4 that are provided on the metal magnetic layer ML.

The insulating body I of the multilayer group G7 is provided so as to correspond to the winding shape of the first coil conductor CD1 of the multilayer group G8, which will be described later. In perspective plan view, the plane area of the insulating body I of the multilayer group G7 is designed to be greater than the plane area of the first coil conductor CD1 of the multilayer group G8. Accordingly, the insulating body I of the multilayer group G7 includes a region that overlaps the first coil conductor CD1 and a region that protrudes from the first coil conductor CD1 in perspective plan view.

The via conductor V of the multilayer group G7 is disposed at a position at which a connection is made to one end of the first coil conductor CD1 of the multilayer group G6.

The second through-hole conductor T2 of the multilayer group G7 connects, to each other, the second through-hole conductors T2 of the multilayer groups G6 and G8 adjacent to each other in the lamination direction and is electrically connected to the second outer electrode E2. Accordingly, the second through-hole conductor T2 is disposed above the second outer electrode E2 in perspective plan view.

The third through-hole conductor T3 of the multilayer group G7 connects, to each other, the third through-hole conductors T3 of the multilayer groups G6 and G8 adjacent to each other in the lamination direction and is electrically connected to the third outer electrode E3. Accordingly, the third through-hole conductor T3 is disposed above the third outer electrode E3 in perspective plan view.

The fourth through-hole conductor T4 of the multilayer group G7 connects, to each other, the fourth through-hole conductors T4 of the multilayer groups G6 and G8 adjacent to each other in the lamination direction and is electrically connected to the fourth outer electrode E4. Accordingly, the fourth through-hole conductor T4 is disposed above the fourth outer electrode E4 in perspective plan view.

### (Multilayer Group G8)

The multilayer group G8 includes the metal magnetic layer ML, an insulating body (not illustrated) provided on the metal magnetic layer ML, the first coil conductor CD1, formed on the insulating body, that constitutes a portion of the first coil C1, and the second through-hole conductor T2, the third through-hole conductor T3, and the fourth through-hole conductor T4 that are provided on the metal magnetic layer ML.

The first coil conductor CD1 of the multilayer group G8 constitutes another winding of the first coil C1. More specifically, the second coil conductor CD2 is disposed on an insulating body formed in the thickness direction of the metal magnetic layer ML along substantially the outer peripheral edge of the metal magnetic layer ML. One end of the first coil conductor CD1 is connected to the first coil conductor CD1 provided on the insulating body of the metal magnetic layer ML of the multilayer group G6, and the other end of the first coil conductor CD1 is provided with a first through-hole conductor (not illustrated) for electrically connecting to a first outer electrode E1.

The second through-hole conductor T2 of the multilayer group G8 connects, to each other, the second through-hole conductors T2 of the multilayer groups G7 and G9 adjacent to each other in the lamination direction and is electrically connected to the second outer electrode E2. In addition, the second through-hole conductor T2 may be disposed at a corner portion of the metal magnetic layer ML located above the second outer electrode E2.

The third through-hole conductor T3 of the multilayer group G8 connects, to each other, the third through-hole conductors T3 of the multilayer groups G7 and G9 adjacent to each other in the lamination direction and is electrically connected to the third outer electrode E3. In addition, the third through-hole conductor T3 may be disposed at a corner portion of the metal magnetic layer ML located above the third outer electrode E3.

The fourth through-hole conductor T4 of the multilayer group G8 connects, to each other, the fourth through-hole conductors T4 of the multilayer groups G7 and G9 adjacent to each other in the lamination direction and is electrically connected to the fourth outer electrode E4. In addition, the fourth through-hole conductor T4 may be disposed at a corner portion of the metal magnetic layer ML located above the fourth outer electrode E4.

### (Multilayer Group G9)

The multilayer group G9 is provided with the first through-hole conductor T1, the second through-hole conductor T2, the third through-hole conductor T3, and the fourth through-hole conductor T4 at the corner portions of the metal magnetic layer ML. The areas of the first through-hole conductor T1 to the fourth through-hole conductor T4 of the multilayer groups G1 to G9 as viewed in the lamination direction are substantially the same as each other.

### (Multilayer Group G10)

The multilayer group G10 is provided with first to fourth through-hole conductors T1 to T4 that have greater plane areas than the first to fourth through-hole conductors of the multilayer group G9 at the corner portions of the metal magnetic layer ML. The first to fourth through-hole conductors T1 to T4 are used as the base electrodes for the outer electrodes E1 to E4. Since the plane areas of the first to fourth through-hole conductors of the multilayer group G10 are greater than the plane areas of the first to fourth through-hole conductors of the multilayer group G9, the strength during mounting can be improved.

The thicknesses of the first coil conductors CD1 and the second coil conductors CD2 in the individual multilayer groups may be the same. An example of the material of the first coil conductor CD1 and the second coil conductor CD2 is a conductor of a metal, such as Ag or Cu. The first coil conductor CD1 and the second coil conductor CD2 may be formed, for example, by applying a conductive paste onto the metal magnetic layers ML.

The first through-hole conductor T1 to the fourth through-hole conductor T4 and the via conductor may be, for example, conductors of metals, such as Ag or Cu. In addition, the materials of the first through-hole conductor T1 to the fourth through-hole conductor T4 and the via conductor may be of the same as or different from the material of the first coil conductor CD1 and the second coil conductor CD2 described above. The through-hole conductors and the via conductor may also be formed by, for example, creating through-holes in the metal magnetic layer ML described above and applying a conductive paste into the through-holes or applying a conductive paste and then applying the metal magnetic layer (ML) outside the conductive paste.

As described above, when the body 10 has a multilayer structure including the multilayer group G1 to the multilayer group G10, the design freedom of the multilayer inductor 1 becomes higher. For example, when the multilayer inductor 1 that includes the first outer electrode E1, the second outer electrode E2, the third outer electrode E3, and the fourth outer electrode E4 is manufactured on the bottom surface (first main surface 11) of the body 10, the first coil C1 and the second coil C2 can be easily drawn toward the bottom surface. It should be noted that the multilayer structure including the multilayer group G1 to the multilayer group G10 may also be formed by sequentially applying (for example, screen printing), from the second main surface 12 or the first main surface 11 of the body 10, the material that constitutes the metal magnetic layer ML, the material that constitutes the insulating body I, the material that constitutes the coil conductor CD, and the material that constitutes the through-hole conductor and via conductor in a laminated manner. In this case, in each of the multilayer group G1 to the multilayer group G10, the metal magnetic layer ML, the insulating body I, the coil conductor, the through-hole conductor, and the via conductor may be applied repeatedly until they each have a desired thickness.

The metal magnetic layer ML includes metal magnetic particles MP made of a magnetic material (see FIG. 4). The metal magnetic particles MP contain Fe (iron). More specifically, the metal magnetic particles MP may be Fe particles or Fe alloy particles. The Fe alloy may be Fe—Si-based alloy, Fe—Si—Cr (chromium)-based alloy, Fe—Si—Al (aluminum)-based alloy, an Fe—Si—B (boron)-P (phosphorus)-Cu (copper)-C (carbon)-based alloy, Fe—Si—B—Nb (niobium)-Cu-based alloy, or the like. In addition, the metal magnetic particles MP may contain unintended manufacturing impurities, such as Cr, Mn (manganese), Cu, Ni (nickel), P, S (sulfur), or Co (cobalt). In addition, the metal magnetic particles MP may be contained in the magnetic paste, as described in detail in the description of the manufacturing method. Accordingly, the metal magnetic particles may contain elements (for example, Cr, Al, Li (lithium), or Zn (zinc)) that are more likely to be oxidized than Fe, which is added during production of the magnetic paste. Since the metal magnetic particles MP contain Si, oxidation of the Fe elements contained in the metal magnetic particles can be suppressed, and accordingly, the magnetic permeability of the multilayer inductor 1 can be enhanced.

The surface of the metal magnetic particle MP made of the metal magnetic material described above may be covered with an insulation coating (not illustrated). The insulating properties in this specification refer to a volume resistivity of 1 MΩcm or greater. When the surface of the metal magnetic particle MP is covered with an insulation coating, the insulating properties between the metal magnetic particles MP can be increased. A sol-gel method, a mechanochemical method, or the like can be used as the method of forming an insulation coating on the surface of the metal magnetic particle (MP). The material constituting the insulation coating may be a Por Si oxide. In addition, the insulation coating may be an oxide film formed by oxidation of the surface of the metal magnetic particle MP. The thickness of the insulation coating is preferably 1 nm or more and 50 nm or less (i.e., from 1 nm to 50 nm), more preferably 1 nm or more and 30 nm or less (i.e., from 1 nm to 30 nm), and even more preferably 1 nm or more and 20 nm or less (i.e., from 1 nm to 20 nm). For example, the thickness of the insulation coating that covers the surface of the metal magnetic particle can be measured by polishing a sample of the inductor and taking SEM images of the obtained cross section with a scanning electron microscope (SEM) or a transmission electron microscope (TEM).

The average particle diameter of the metal magnetic particles MP in the metal magnetic layer ML is preferably greater than 2 μm and 30 μm or less (i.e., from greater than 2 μm to 30 μm), more preferably greater than 2 μm and 20 μm or less (i.e., from greater than 2 μm to 20 μm), and even more preferably greater than 2 μm and 10 μm or less (i.e., from greater than 2 μm to 10 μm). The average particle diameter of the metal magnetic particles MP in the metal magnetic layer ML can be measured by using the procedure described below. The sample of the inductor is cut to obtain a cross section of the sample. Specifically, a cross section of the sample is obtained by cutting the sample so as to pass through the center of the body orthogonally to the mount surface and the end face of the body. In the obtained cross section, images of a plurality of (for example, five) regions (for example, 130 μm×100 μm) are taken with a scanning electron microscope (SEM), and the obtained SEM images are analyzed by using image analysis software (for example, image analysis software Win ROOF produced by Mitani Corporation) to determine the equivalent circular diameter of the metal magnetic particles. The average value of the obtained equivalent circular diameter is taken as the average particle diameter of the metal magnetic particles. It should be noted that the average particle diameter in this specification may refer to a median particle diameter D50 (particle diameter corresponding to a cumulative volume percentage of 50%).

A heat treatment is applied to form the body 10. In this case, the metal magnetic particles MP contained in the body 10 each have an oxide film on its surface. This oxide film is derived from the metal magnetic particles MP and is formed by the heat treatment. In the body 10, adjacent metal magnetic particles MP are joined to each other through the oxide film.

As illustrated in FIGS. 3 and 4, in the body 10, the insulating body I is disposed between the coil conductors CD in the lamination direction. Specifically, as described above, the insulating body I may be disposed on each of the multilayer groups G2 to G7 (see FIG. 2). The insulating body I includes a contact portion I1, in contact with the coil conductors CD, that extends in a direction intersecting the lamination direction and protruding portions I2 that protrude outward of both sides of each of the coil conductors CD in the direction intersecting the lamination direction.

The contact portion in this specification refers to the region in which the coil conductors CD are in contact with the insulating body I. Specifically, as illustrated in FIGS. 3 and 4, the contact portion refers to the region, inside the thin regions at both ends of the coil conductors CD in the direction orthogonal to the lamination direction, that is located inside non-contact positions P1 in the direction orthogonal to the lamination direction on the outermost side at which the coil conductors CD are not in contact with the insulating body I. In addition, the determination as to whether the coil conductors CD are in contact with the insulating body I is made by SEM observation at a magnification of 1000 times in which the coil conductors CD and the insulating body I are within the field of view.

In addition, the protruding portions in this specification are provided at both ends of the contact portion I1 in the direction orthogonal to the lamination direction. Specifically, the protruding portions refer to the region that includes not only the tips that protrude from both ends of the coil conductors in the direction orthogonal to the lamination direction, but also, as illustrated in FIG. 4, the non-contact positions P1 as the start points in the direction orthogonal to the lamination direction on the outermost side at which the coil conductors CD are not in contact with the insulating body I and extends outward of the coil conductors CD.

In the characteristic structure of the inductor according to the embodiment, the thickness of the entire protruding portions I2 is smaller than the thickness of the contact portion I1. The thickness of the protruding portions I2 and the thickness of the contact portion I1 can be measured by the process described below.

First, the sample of the inductor is kept upright and the area around the sample is filled with resin. At this time, an LT surface is exposed. A depth of approximately ½ of the sample in the W direction is polished by a polisher to expose a cross section parallel to the LT surface. After polishing is completed, the polished surface is machined by using an ion milling device (IM4000 manufactured by Hitachi High-Tech Corporation) to remove the droop of the internal conductor caused by polishing. Images of the cross section are taken at a magnification of 1000 times by using a scanning electron microscope (manufactured by JEOL Ltd., model JSM-7900F) such that the coil conductors CD and the insulating body I are within the field of view.

As illustrated in FIG. 4, the thickness of the contact portion I1 is calculated as the average of the thicknesses of three portions: a central portion O1 of the portion in which the insulating body I is in contact with the coil conductors CD and intermediate positions O2 and O2 between the central portion O1 and the non-contact positions P1.

As illustrated in FIG. 4, the thickness of the protruding portion I2 is calculated as the average of the measured thicknesses of a total of six portions: an intermediate position P2 between the non-contact position P1 and tips PE of the protruding portion I2, an intermediate position P3 between the tip PE and the intermediate positions P2, an intermediate position P4 between the non-contact position P1 and the intermediate position P2, and the other three positions for the other protruding portion I2 of the contact portion I1.

As described above, the present disclosure uses the average thickness of the contact portion I1 and the average thickness of the protruding portions I2 as the judgment criterion, and the insulating properties between the coil conductors CD can be ensured by the insulating body I while reduction in the flow of magnetic flux due to the protruding portions I2 of the insulating body I is suppressed by making the thickness of the protruding portions I2 smaller than the thickness of the contact portion I1. In addition, the judgment criterion of the average thickness of the contact portion I1 and the average thickness of the protruding portions I2 is preferably 50% or greater than the thickness of the insulating body I and the coil conductors CD in the cross section in FIG. 3, more preferably 80% or greater.

When the thickness of the insulating body I is identified more specifically, the thickness of both end portions in a direction orthogonal to the lamination direction of the insulating body I is smaller than the thickness of the central portion in the direction orthogonal to the lamination direction of the insulating body I. When the thickness of the insulating body I satisfies the relationship described above, the insulating properties between the coil conductors CD can be ensured by the insulating body I while reduction in the flow of magnetic flux due to both end portions of the insulating body I is suppressed.

In a preferable aspect of the thinned protruding portions I2, recessed portions RC may be provided on the surfaces of the protruding portions I2, and the metal magnetic particles MP may be disposed in the recessed portions RC. Specifically, as illustrated in FIG. 4, the metal magnetic particles MP may enter the recessed portions RC on the surfaces of the protruding portions I2. It should be noted that the reason why the metal magnetic particles MP enter the recessed portions RC of the protruding portions I2 will be described in detail in the method of manufacturing the multilayer inductor 1 described later. In such an aspect of the thinned protruding portions I2, reduction in the magnetic permeability due to the protruding portions I2 can be suppressed.

The size of the recessed portions RC is equal to or greater than the diameter of the metal magnetic particles. When the size of the recessed portions RC is equal to or greater than the particle diameter of the metal magnetic particles, the metal magnetic particles MP can appropriately enter the recessed portions RC.

The insulating body I may include a material with higher insulating properties and lower magnetic permeability than the magnetic body formed by laminating the metal magnetic layers ML together. Since the insulating body I includes such a material, reduction in the magnetic permeability can be suppressed while the insulation property is ensured.

In more specific characteristics of the insulating body I, the insulating body I may have non-magnetic properties. In the non-magnetic property in this specification, the magnetic permeability is 1. Since the thickness of the protruding portions I2 of the insulating body I is smaller than that of the contact portion I1 even in such a material, reduction in the magnetic permeability can be further suppressed.

The material of the insulating body I according to the embodiment may include at least one selected from the group consisting of non-magnetic ferrite, alumina, glass, and zirconia. The insulating properties between the coil conductors CD can be further improved by using such a material.

The first coil C1 and the second coil C2 are provided in the body 10. The first coil C1 and the second coil C2 may be magnetically coupled to each other. For example, the coupling coefficient between the first coil C1 and the second coil C2 is 0.1 or more and 0.8 or less (i.e., from 0.1 to 0.8). It should be noted that two coils that include the first coil C1 and the second coil C2 may be provided in the body 10, or three or more coils that include the first coil C1 and the second coil C2 may be provided in the body 10.

### —First Coil—

The first coil C1 is provided in the body 10. The first coil C1 includes the plurality of first coil conductors CD1 connected to each other by the via conductor V (see FIG. 3), the first through-hole conductor T1, and the second through-hole conductor T2.

The plurality of first coil conductors CD1 are provided on the two multilayer groups (multilayer groups G6 and G8 (see FIG. 2)), as described above. As a result, the first coil C1 has a two-layer structure with 1.75 turns. In addition, the length in the lamination direction of the via conductor V that connects the plurality of first coil conductors CD1 to each other may be smaller than the length of the first through-hole conductor T1 or the length of the second through-hole conductor T2.

The first through-hole conductor T1 electrically connects an end portion of the first coil conductor CD1 of the first coil C1 that is closest to the bottom surface (first main surface 11) of the body 10 and the first outer electrode E1 to each other. The first through-hole conductor T1 extends in the lamination direction (for example, in the height direction T of the body) of the metal magnetic layers. The first through-hole conductor T1 may have a multilayer structure.

The second through-hole conductor T2 electrically connects the other end portion of the first coil C1 and the second outer electrode E2 to each other. The second through-hole conductor T2 extends in the lamination direction (for example, in the height direction T of the body) of the metal magnetic layers. The second through-hole conductor T2 may have a multilayer structure.

### —Second Coil—

In the body 10, the second coil C2 may be provided above the first coil C1 in the lamination direction. The second coil C2 may include the plurality of second coil conductors CD2 connected to each other by a via conductor (not illustrated), the third through-hole conductor T3, and the fourth through-hole conductor T4.

The plurality of second coil conductors CD2 may be provided on the two multilayer groups (multilayer groups G2 and G4 (see FIG. 2)) as described above. As a result, the second coil C2 may have a two-layer structure with 1.75 turns. In addition, the length in the lamination direction of the via conductor (not illustrated) that connects the plurality of second coil conductors CD2 to each other may be smaller than the length of the third through-hole conductor T3 or the length of the fourth through-hole conductor T4.

The third through-hole conductor T3 may electrically connect an end portion of a second winding portion of the second coil C2 that is closest to the bottom surface (first main surface 11) of the body 10 and the third outer electrode E3 to each other. The third through-hole conductor T3 may extend in the lamination direction (for example, in the height direction T of the body) of the metal magnetic layer. The third through-hole conductor T3 may have a multilayer structure.

The fourth through-hole conductor T4 may connect the other end portion of the second coil C2 and the fourth outer electrode E4 to each other. The fourth through-hole conductor T4 may extend in the lamination direction (for example, in the height direction T of the body) of the metal magnetic layer. The fourth through-hole conductor T4 may have a multilayer structure.

As described above, in the insulating body I disposed between the coil conductors CD in the lamination direction of the multilayer inductor 1 according to the embodiment, since the thickness of the protruding portions I2 that extrude outward of both sides of each of the coil conductors CD is smaller than the thickness of the contact portion I1 in contact with the coil conductors CD, reduction in the flow of magnetic flux due to the insulating body I is suppressed, and accordingly, reduction in the magnetic permeability can be suppressed as compared with the related art.

In a preferable aspect of the multilayer inductor 1, a thickness D1 of both end portions in a direction intersecting the lamination direction of each of the coil conductors CD that constitute the first coil C1 or the second coil C2 may be smaller than a thickness D2 of the central portion in the direction intersecting the lamination direction of each of the coil conductors CD (see FIG. 3).

Here, the thickness D2 of the central portion of each of the coil conductors CD may be calculated as the average of the thicknesses of a total of three positions: the central portion and any two positions in the vicinity of the central portion. In addition, the thickness D1 of both end portions of the coil conductor CD may be calculated as the average of the thicknesses of a total of three portions: the tip position of each of the coil conductors CD and any two portions in the vicinity of the tip position. It should be noted that the vicinity refers to the region within 10% of the length of each of the coil conductors CD in the direction intersecting the lamination direction from the central portion. The thickness of the coil conductors CD may be measured in accordance with SEM images.

When the thickness of the coil conductors CD satisfies the relationship described above, magnetic flux can be properly formed by the coil conductors CD.

### —Outer Electrodes—

The outer electrodes are provided on the bottom surface of the body 10. The outer electrodes include the first outer electrode E1, the second outer electrode E2, the third outer electrode E3, and the fourth outer electrode E4. The first outer electrode E1 and the second outer electrode E2 are electrically connected to the first coil C1. In addition, the third outer electrode E3 and the fourth outer electrode E4 are electrically connected to the second coil C2. When the outer electrodes are provided on the bottom surface (first main surface 11) of the body 10, the multilayer inductor 1 can be appropriately mounted on a mounting board or the like.

The materials of the outer electrodes may include various materials, such as, for example, Cu (copper) or Ni (nickel). In addition, each of the outer electrodes may include a single layer or have a multilayer structure including two or more layers. The outer electrodes may be formed by any method and may be, for example, plated electrodes formed by plating (for example, electroless plating).

### <Multilayer Inductor According to Second Embodiment>

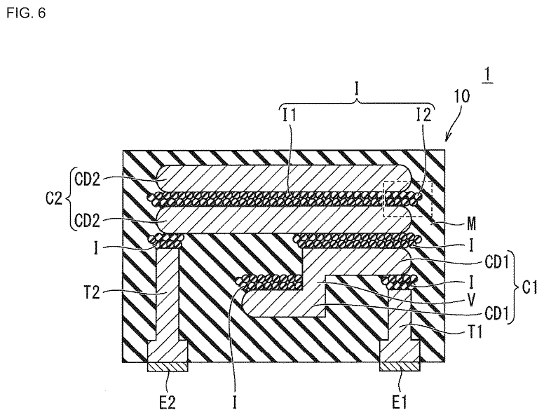

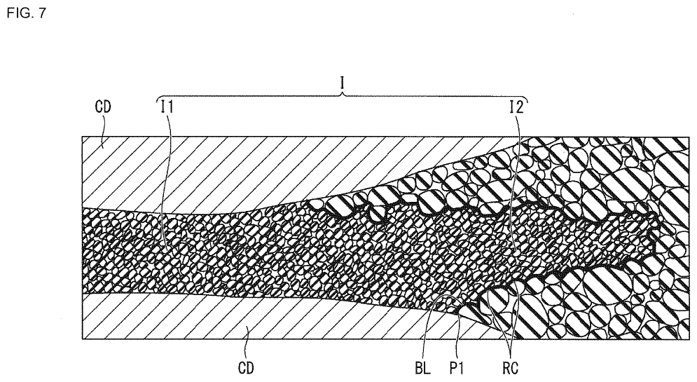

A multilayer inductor according to a second embodiment of the present disclosure will be described with reference to FIGS. 6 and 7. FIG. 6 is a cross-sectional view of the multilayer inductor according to the second embodiment, and FIG. 7 is an enlarged cross-sectional view of a main portion in FIG. 6. The multilayer inductor according to the second embodiment differs from the multilayer inductor according to the first embodiment in which a non-magnetic body is used in the insulating body I in that metal magnetic particles are used in the insulating body I. Since the remaining structure is the same as that of the multilayer inductor 1 described above, the differences from the multilayer inductor according to the first embodiment will be mainly described.

The insulating body I contains metal magnetic particles in the multilayer inductor 1 according to the embodiment, and the average particle diameter of the metal magnetic particles contained in the insulating body I is smaller than the average particle diameter of the metal magnetic particles contained in the magnetic body M.

Specifically, the average particle diameter of the metal magnetic particles contained in the magnetic body M is greater than 2 μm and 30 μm or smaller (i.e., from greater than 2 μm to 30 μm), more preferably greater than 2 μm and 20 μm or smaller (i.e., from greater than 2 μm to 20 μm), and even more preferably greater than 2 μm and 10 μm or smaller (i.e., from greater than 2 μm to 10 μm), as described above. On the one hand, the average particle diameter of the metal magnetic particles contained in the insulating body I is 2 μm or smaller. It is known that the metal magnetic particles with a smaller average particle diameter generally have a higher insulation resistance.

When magnetic particles with a relatively great average particle diameter and metal magnetic particles with a relatively small average particle diameter are used to form the magnetic body M and the insulating body I as described above, the metal magnetic particles with a small average particle diameter are more easily mixed with the metal magnetic particles with a great average particle diameter. Accordingly, by causing the insulating body I to get into the magnetic body M that constitutes the body 10 and reducing the thickness of both end portions of the insulating body I, the insulation resistance can be increased by reducing the particle diameter of the metal magnetic particles of the insulating body I when the flow of magnetic flux is reduced by both end portions of the insulating body I. As a result, the insulating properties of the coil conductor can be ensured even when the magnetic body M of the body 10 gets into the insulating body I.

Here, the boundary between the metal magnetic particles with a relatively great average particle diameter and the metal magnetic particles with a relatively small average particle diameter can be measured by using the procedure described below.

First, the sample of the inductor is kept upright and the area around the sample is filled with resin. At this time, the LT surface is exposed. A depth of approximately ½ of the sample in the W direction is polished by a polisher to expose a cross section parallel to the LT surface. After polishing is completed, the polished surface is machined by using an ion milling device (IM4000 manufactured by Hitachi High-Tech Corporation) to remove droop of the internal conductor caused by polishing. Images of the cross section are taken at a magnification of 1000 times by using a scanning electron microscope (manufactured by JEOL Ltd., model JSM-7900F) such that the coil conductors CD and the insulating body I are within the field of view.

The SEM images are loaded into image analysis software Win ROOF (Mitani Corporation), and the equivalent circular diameter of the metal magnetic particles near the end portion of the coil conductors in the direction orthogonal to the lamination direction between the laminated coil conductors CD is obtained. This identifies the positional relationship between the region containing the metal magnetic powder with a great particle diameter and the region containing the metal magnetic powder with a small particle diameter. Then, the boundary BL between the region containing the metal magnetic powder with a great particle diameter and the region containing the metal magnetic powder with a small particle diameter is drawn as illustrated in FIG. 7.

Then, the thickness of the protruding portion I2 and the thickness of the contact portion I1 are measured by the method described above. Since the thickness of the protruding portion I2 is smaller than the thickness of the contact portion I1 also in the multilayer inductor 1 according to the embodiment, the insulating properties between the coil conductors CD can be ensured by the insulating body I while reduction in the flow of magnetic flux due to the protruding portion I2 of the insulating body I is suppressed.

In the insulating body I according to the embodiment, the material of the metal magnetic particles contained in the insulating body I contains Fe. That is, unlike the first embodiment, the insulating body I is a magnetic body. Accordingly, reduction in the magnetic permeability can be further reduced as compared with the first embodiment while reduction in the flow of the magnetic flux is suppressed. It should be noted that the material of the metal magnetic particles contained in the insulating body I may be the same as the material of the magnetic body M or may be different from the material of the magnetic body.

### <Method of Manufacturing Multilayer Inductor>

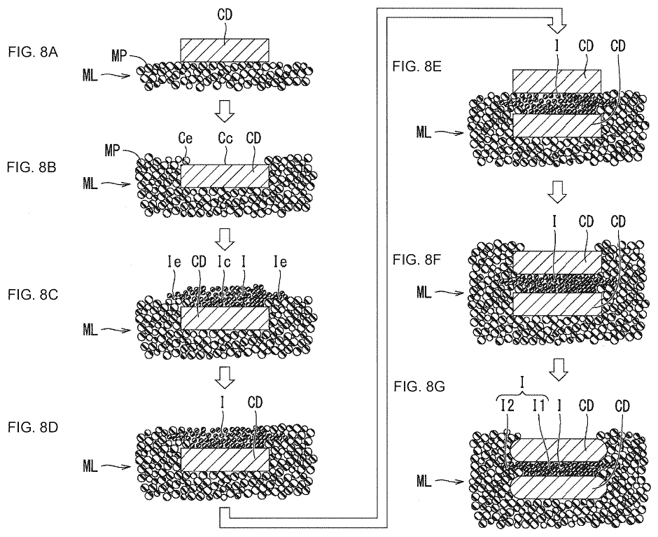

Next, the method of manufacturing the multilayer inductor according to the present disclosure will be described with reference to FIGS. 8A to 8G. The method of manufacturing the multilayer inductor according to the present disclosure may include a body forming process.

### —Body Forming Process—

The body forming process includes a multilayer body forming process for forming the multilayer body constituting the body 10 and a firing process for firing the multilayer body.

### —Multilayer Body Forming Process—

First, the metal magnetic layer ML is prepared. The metal magnetic Layer ML is prepared by applying and stacking magnetic pastes that contain metal magnetic particles MP with an average particle diameter of preferably 1 μm or more to 30 μm or less (i.e., from 1 μm to 30 μm), more preferably 1 μm or more and 20 μm or less (i.e., from 1 μm to 20 μm), and even more preferably 1 μm or more and 10 μm or less (i.e., from 1 μm to 10 μm). Then, a conductive paste that becomes the coil conductor CD is applied onto the prepared metal magnetic layer ML to form one multilayer group (see FIG. 8A). For example, the multilayer group G8 illustrated in FIG. 2 is formed.

The magnetic paste containing the metal magnetic particles (MP) described above is applied onto the formed multilayer group (see FIG. 8B). In the application of the magnetic paste, the metal magnetic layer ML is applied such that an end portion Ce of the coil conductor CD in the width direction is covered, and a central portion Cc of the upper surface of the coil conductor is exposed.

Next, the insulating body I is applied over the central portion Cc in the width direction of the upper surface of the coil conductor CD and the metal magnetic layer ML that covers the end portion Ce of the upper surface of the coil conductor CD (see FIG. 8C). At this time, the insulating body I is applied such that the thickness of a central portion Ic in the width direction of the upper surface of the coil conductor CD is great, the thickness of both end portions Ie in the width direction of the upper surface of the coil conductor CD is small, and the upper surface of the insulating body I located in the central portion Ic in the width direction of the upper surface of the coil conductor CD projects beyond the upper surfaces of the insulating body I located in the both end portions Ie in the width direction of the upper surface of the coil conductor CD. It should be noted that the upper surface located in the central portion Ic does not need to project beyond the upper surfaces located in both end portions Ie and may be flush with the upper surfaces located in the both end portions Ie.

Next, the magnetic paste is applied onto the surrounding of the insulating body I to form the portions other than the coil conductor of the multilayer group G6 and the multilayer group G7 on the multilayer group G8, as illustrated as an example in FIG. 2 (see FIG. 8D). In addition, the conductive paste that becomes the coil conductor CD is applied onto the formed multilayer group (see FIG. 8E), and the magnetic paste that constitutes the metal magnetic layer ML is applied to the surrounding of the conductive paste (see FIG. 8F). These processes are repeated to laminate the multilayer groups illustrated in FIG. 2 together.

After the multilayer groups are laminated together, the multilayer groups are compressed in the lamination direction (see FIG. 8G). This compression forms the multilayer body in which the insulating body I is compressed to narrow the gap between the coil conductors CD and the insulating body I gets into the magnetic body M. As a result, in the multilayer inductor 1 according to the present disclosure, the thickness of the protruding portions I2 described above can be smaller than the thickness of the contact portion I1, and the insulating properties between the coil conductors CD can be ensured while reduction in the flow of magnetic flux due to the protruding portions I2 of the insulating body I is suppressed.

### —Heat Treatment Process—

Degreasing that removes the binder contained in the magnetic paste and the conductive paste from the formed multilayer body is performed, and then heat treatment is performed. The heat treatment forms an oxide film and couples the metal magnetic particles together via the oxide film. The temperature of the heat treatment may be, for example, approximately 700° C. In addition, the multilayer body may be impregnated with resin and then solidified to enhance the strength of the multilayer body. The resin with which the multilayer body is impregnated is typically epoxy resin, but more than one selected from the group consisting of phenolic resin, polyester resin, polyimide resin, polyolefin resin, silicone resin, acrylic resin, polyvinyl butyral resin, cellulose resin, and alkyd resin may also be used. The body of the multilayer inductor according to the present disclosure is formed by the process described above.

After the body 10 is formed by the process described above, the multilayer inductor 1 according to the present disclosure can be manufactured by the outer electrodes E1 to E4 being formed on the mount surface (first main surface 11) of the body 10 by a well-known electrode formation method.

It should be noted that the aspects disclosed herein are only illustrative in all respects and do not serve as a basis for limited interpretation. For example, the method that lowers the content of the non-magnetic material (FIG. 4) and the metal magnetic powder in the insulating paste by making the amount of resin component in the insulating paste greater than the resin component in the magnetic paste containing the metal magnetic particles may be adopted as the method of making the thickness of the protruding portions of the insulating body smaller than the thickness of the contact portion. Use of the method described above compresses the insulating body in the compression direction when the multilayer groups are compressed in the lamination direction, causes the magnetic powder of the multilayer body to get into the protruding portions at both ends of the insulating body, and causes the magnetic powder of the multilayer body to further get into the protruding portions at both ends of the insulating body during degreasing in the heat treatment process, and accordingly, the thickness of both ends of the insulating body can be further reduced. In addition, the insulating body I between the first coil C1 and the second coil C2 may be formed over the entire circumference in the winding direction of the coils or may have the same area as the metal magnetic layer. In addition, the insulating body I between the first coil C1 and the second coil C2 does not need to be provided. However, when the insulating body I is provided between the first coil C1 and the second coil C2, the withstand voltage between the coils can be improved and the coupling between the coils can be adjusted.

In addition, the technical scope of the present disclose is not interpreted only by the embodiments described above and is defined in accordance with the description of the claims. In addition, the technical scope of the present disclose includes the meaning equivalent to the claims and all modifications within the scope.

The inductor according to the present disclosure includes aspects described below.

<1> A multilayer inductor comprising: a body including a magnetic body in which metal magnetic layers containing metal magnetic particles are laminated together, a coil, disposed in the magnetic body, that is formed by winding coil conductors, and an insulating body disposed between the coil conductors in a lamination direction. The insulating body includes a contact portion, in contact with the coil conductors, that extends in a direction orthogonal to the lamination direction, and protruding portions, provided at both ends of the contact portion in the direction orthogonal to the lamination direction, that extend outward of both sides of each of the coil conductors in the direction orthogonal to the lamination direction. Also, a thickness of the protruding portions is smaller than a thickness of the contact portion.

<2> The multilayer inductor according to <1>, wherein a recessed portion is provided on a surface of each of the protruding portions, and the metal magnetic particles are disposed in the recessed portion.

<3> The multilayer inductor according to <1> or <2>, wherein a material of the metal magnetic particles contained in the magnetic body contains Fe and Si.

<4> The multilayer inductor according to any one of <1> to <3>, wherein the insulating body has a higher insulating property and a lower magnetic permeability than the magnetic body.

<5> The multilayer inductor according to any one of <1> to <4>, wherein the insulating body has a non-magnetic property.

<6> The multilayer inductor according to <5>, wherein a material of non-magnetic metal magnetic particles contained in the insulating body contains at least one selected from the group consisting of non-magnetic ferrite, alumina, glass, and zirconia.

<7> The multilayer inductor according to any one of <1> to <6>, wherein the insulating body contains metal magnetic particles, and an average particle diameter of the metal magnetic particles contained in the insulating body is smaller than an average particle diameter of the metal magnetic particles contained in the magnetic body.

<8> The multilayer inductor according to <7>, wherein the metal magnetic particles contained in the insulating body are metal magnetic powder that contain Fe or metal magnetic powder that contain Fe and Si.

<9> The multilayer inductor according to any one of <1> to <8>, wherein a thickness of both end portions of the insulating body in a direction intersecting the lamination direction is smaller than a thickness of a central portion of the insulating body in the direction intersecting the lamination direction.

<10> The multilayer inductor according to any one of <1> to <9>, wherein a thickness of both end portions of each of the coil conductors in the direction orthogonal to the lamination direction is smaller than a thickness of a central portion of each of the coil conductors in the direction orthogonal to the lamination direction.

The present disclosure is applicable to a multilayer inductor that further suppresses reduction in the magnetic permeability while ensuring the insulation property.

What is claimed is:

1. A multilayer inductor comprising:
a body including
a magnetic body in which metal magnetic layers including metal magnetic particles are laminated together,
a coil, in the magnetic body, that is configured by winding coil conductors, and
an insulating body between the coil conductors in a lamination direction,
wherein
the insulating body includes
a contact portion, in contact with the coil conductors, that extends in a direction orthogonal to the lamination direction, and protruding portions, at both ends of the contact portion in the direction orthogonal to the lamination direction, that extend outward of both sides of each of the coil conductors in the direction orthogonal to the lamination direction, and
a thickness of the protruding portions is smaller than a thickness of the contact portion.

2. The multilayer inductor according to claim 1, wherein
a recessed portion is on a surface of each of the protruding portions, and the metal magnetic particles are in the recessed portion.

3. The multilayer inductor according to claim 1, wherein
a material of the metal magnetic particles included in the magnetic body includes Fe and Si.

4. The multilayer inductor according to claim 1, wherein
the insulating body has a higher insulating property and a lower magnetic permeability than the magnetic body.

5. The multilayer inductor according to claim 1, wherein
the insulating body has a non-magnetic property.

6. The multilayer inductor according to claim 5, wherein
a material of non-magnetic metal magnetic particles included in the insulating body includes at least one selected from the group consisting of non-magnetic ferrite, alumina, glass, and zirconia.

7. The multilayer inductor according to claim 1, wherein
the insulating body includes metal magnetic particles, and
an average particle diameter of the metal magnetic particles included in the insulating body is smaller than an average particle diameter of the metal magnetic particles included in the magnetic body.

8. The multilayer inductor according to claim 7, wherein
the metal magnetic particles included in the insulating body are metal magnetic powder that includes Fe or metal magnetic powder that includes Fe and Si.

9. The multilayer inductor according to claim 1, wherein
a thickness of both end portions of the insulating body in the direction orthogonal to the lamination direction is smaller than a thickness of a central portion of the insulating body in the direction orthogonal to the lamination direction.

10. The multilayer inductor according to claim 1, wherein
a thickness of both end portions of each of the coil conductors in the direction orthogonal to the lamination direction is smaller than a thickness of a central portion of each of the coil conductors in the direction orthogonal to the lamination direction.

11. The multilayer inductor according to claim 2, wherein
a material of the metal magnetic particles included in the magnetic body includes Fe and Si.

12. The multilayer inductor according to claim 2, wherein
the insulating body has a higher insulating property and a lower magnetic permeability than the magnetic body.

13. The multilayer inductor according to claim 3, wherein
the insulating body has a higher insulating property and a lower magnetic permeability than the magnetic body.

14. The multilayer inductor according to claim 2, wherein
the insulating body has a non-magnetic property.

15. The multilayer inductor according to claim 3, wherein
the insulating body has a non-magnetic property.

16. The multilayer inductor according to claim 14, wherein
a material of non-magnetic metal magnetic particles included in the insulating body includes at least one selected from the group consisting of non-magnetic ferrite, alumina, glass, and zirconia.

17. The multilayer inductor according to claim 2, wherein
the insulating body includes metal magnetic particles, and
an average particle diameter of the metal magnetic particles included in the insulating body is smaller than an average particle diameter of the metal magnetic particles included in the magnetic body.

18. The multilayer inductor according to claim 17, wherein
the metal magnetic particles included in the insulating body are metal magnetic powder that includes Fe or metal magnetic powder that includes Fe and Si.

19. The multilayer inductor according to claim 2, wherein
a thickness of both end portions of the insulating body in the direction orthogonal to the lamination direction is smaller than a thickness of a central portion of the insulating body in the direction orthogonal to the lamination direction.

20. The multilayer inductor according to claim 2, wherein
a thickness of both end portions of each of the coil conductors in the direction orthogonal to the lamination direction is smaller than a thickness of a central portion of each of the coil conductors in the direction orthogonal to the lamination direction.
